(19) United States
(12) Patent Application Publication
(10) Pub. No.: US 2005/0047579 A1
(43) Pub. Date: Mar. 3, 2005

(54) Telecommunication call distribution system

(76) Inventor: Mansour A. Salame, Palo Alto, CA (US)

Correspondence Address: GERALD B ROSENBERG;NEW TECH LAW, 285 HAMILTON AVE, SUITE 520, PALO ALTO, CA, 94301, US

(21) Appl. No.: 10/928,435

(22) Filed: Aug. 27, 2004

Related U.S. Application Data
(60) Provisional application No. 60/498,914, filed on Aug. 29, 2003.

(51) Int. Cl. H04M 3/00; H04M 5/00

(52) U.S. Cl. 379/265.09

(57) ABSTRACT

A call center server architecture supporting service transactions between service customers and service agents who can be either local to or in geographic distributed locations relative to the call center. The call center server architecture includes an inbound voice packetizer providing a PSTN line interface to the call center, a call center server system, coupled to said inbound voice packetizer, that provides for the execution of call center server control applications, and a router, coupled among said inbound voice packetizer, the call center server system, and, through a network interface to any combination of intra- and extranets, to service agent terminal equipment. The call center server control applications dynamically determine the routing and distribution of service requests received from service customers to service agents and are dynamically responsive to determinations of inadequate quality of service for individual communications channels. The call center server control applications provide for the controlled interruption of a predetermined service transaction while establishing a new communications channel having an adequate quality of service.

This application claims the benefit of U.S. Provisional Application No. 60/498,914, all filed Aug. 29, 2003.

### BACKGROUND OF THE INVENTION

1. Field of the Invention

The present invention is generally related to telecommunications-based call centers and, in particular, to a unified call center system architecture capable of efficiently and productively handling multiple communications channels and the methods of operating such a call center.

2. Description of the Related Art

Remotely-based customer service centers, variously referred to as call centers, telecom-contact centers, hosted contact centers, and network-based contact centers, are an increasingly common business unit in today's service oriented business and consumer markets. Customer service centers enable customers to conduct typically telecom-based transactions with call agents. The types of transactions that can be conducted include but are not limited to sales, reservations, credit card verification, stock transactions, yellow pages, and customer support services. The traditional call center system architecture includes a private branch exchange (“PBX”) system and an Automatic Call Distribution (“ACD”) system. A PBX is a private telephone network that allows users to share a certain number of outside lines for making telephone calls external to the PBX. A PBX is less expensive than connecting an external telephone line to every telephone in the organization. In addition, making calls within the scope of a PBX system is easier because the internal extension designator is typically just 3 or 4 digits. An ACD system routes and queues calls to the appropriate agent, based on various categorization and availability algorithms. For example, one commonly used routing scheme is to send the longest waiting call to the longest available agent. Other commonly used distribution schemes include skills-based routing and priority routing.

In a traditional call center system, each agent is logged into one or more ACD queues on the basis of an internal extension number that is assigned to the telephone equipment used by that agent. When a customer contacts a company via the call center, the call is initially queued. The customer is then typically prompted in queue to “press one for sales,” “press two for custom service,” and so on with the result that the call is selectively transferred to another queue to await servicing by an appropriate group of customer service agents. The ACD system thus acts as a connection manager for callers. However, the drawback to conventional ACD systems is that the routing of inbound and outbound calls is based on circuit switching through the PBX.

While traditional call centers are a product of the telephone industry, modern call centers evolved to encompass new communication channels, such as voice mail, video and voice over Internet protocol (“VoIP”), Internet text chat (also variously referred to as “online chat,” “keyboard chat,” and “Web chat”), short messages services (“SMS”) text messaging, and e-mail. As a result, some conventional call centers have evolved complex procedural and technical mechanisms, often including dedicated agent groups, to handle the various requirements of the different communications channels.

For example, known call center architectures are required to employ a complex of PBXs and ACD servers to handle customer support transactions initiated through the Public Switched Telephone Network (“PSTN”) to a call center. Conventionally, support calls are routed internal to the call center based on statically predefined agent extensions mapped to agent skills. An enhanced system allows an agent, when logging into the call center server to establish availability to take calls routed from the ACD server, to provide a full call-back telephone number instead of implicitly or explicitly providing an internal extension number. By permitting entry of a full call-back number, as an alternative to just an internal extension number, the service center flexibly permits agents to be distributed anywhere on the PSTN. Groups as small as a single agent can therefore be located in quite different geographical locations, yet still provide support through a single call center.

Supporting distributed groups of agents, however, comes at the cost of the telecommunications charges to connect between the call center and agent. These costs offset the other benefits of supporting distributed agents, particularly where the agent groups are in fundamentally distant geographical locations, for example, in India or in the Philippines. Private telecom lines and PSTN toll charges to distant countries can easily range on the order of $12,000 to $15,000 per month per line if not more.

A call center system developed by White PJ, Inc. supports routing of support transactions between the call center and agents using VoIP connections. The substantial cost of maintaining telecom lines to remote agent groups is thereby substantially avoided. The routing system uses a conventional PSTN to packetized voice switch to route transactions between the call center PBXs and VoIP client equipment used by the agents. The cost of supporting VoIP-based agents, both internal to a call center and geographically distributed, is both substantial equivalent and comparatively minimal.

There is, however, a fundamental limitation of existing VoIP call center systems. Known PSTN to packetized voice switches are statically configured. Consequently, each time an agent changes location, regardless of whether the change is internal to the call center or to a different remote location, the switch must be correspondingly reconfigured to match agents to IP addresses. Beyond requiring significant management costs, switch reconfigurations increase the exposure to significant reductions in productivity and even downtime should the switch be misconfigured. As a result, there is a reduction in flexibility, since remote agents in particular are not able to dynamically change their location for providing support.

Another known problem with VoIP systems is the inability to assure an adequate quality of service level for voice communications. The Internet at large was not designed to guarantee any particular minimum packet delivery latency level or even a minimum packet delivery success rate. VoIP connections over the Internet and, indeed, over some intranets, can noticeably degrade as a result of packet path congestion. While the congestion is often due to burst packet transmissions, the congestion may be sufficiently persistent to make VoIP communications difficult. As a result, the VoIP connection is dropped. In the context of a call center, the corresponding PSTN originated customer service call is also dropped, requiring the customer to redial the call center and restart the service request.

A VoIP system employing a PSTN fallback scheme, as described in U.S. Pat. Nos. 6,542,499 and 6,282,192, is designed to maintain an adequate quality of VoIP communications in the presence of generalized Internet congestion. This VoIP system relies on proprietary gateway hardware at both the source and destination of the VoIP connection to support establishment of a multilink-capable network connection. As described, the gateways support automatic creation of an integrated services digital network (“ISDN”) connection over a digital data qualified circuit-switched line whenever the VoIP quality degrades. Since the ISDN connection is routed over the PSTN, Internet congestion is avoided. The gateways use the ISDN connection in a multilink-mode, enabling the voice data packets routed in part over the Internet and in part over the PSTN to be merged at the destination gateway into a single VoIP stream.

A number of problems exist with such VoIP/PSTN failback systems. Perhaps the most significant is that, in the presence of Internet congestion, whatever VoIP data packets are sent over the Internet are still subject to transmission latency and packet loss problems. Unless the ISDN path is used for the substantial majority of VoIP data packets, the VoIP call will be subject to noticeable degradation. Another problem is the significant cost of maintaining the ISDN channel. U.S. Pat. Nos. 6,542,499 and 6,282,192 suggest that the costs can be shared and thus effectively minimized by concurrently routing parts of multiple VoIP calls over the ISDN channel. Where the Internet congestion is sufficient to affect multiple VoIP calls, the naturally limited bandwidth of an ISDN channel is likely to be insufficient to ensure adequate quality for all of the VoIP calls affected.

Perhaps a more fundamental problem with VoIP/PSTN fallback systems is the necessity of the destination gateway in particular. The cost of provisioning both the source and destination gateways is alone significant. The cost of providing a destination gateway to each remotely located service agent or small group of agents, however, is likely prohibitive, particularly where separate ISDN lines must be qualified to the destination site. Indeed, the flexibility of ad hoc siting of service agents is generally infeasible and further fundamentally limited to areas serviceable by ISDN lines. Large portions of the currently available PSTN, particularly in other countries, remain unreachable by any ISDN terminal equipment. Therefore, VoIP/PSTN fullback systems appear only suitable to support significant auxiliary call center installations where the grouping of a large number of service agents in a major PSTN market location will achieve a reasonable level of cost effectiveness to permit use.

Even with the limitations of existing systems, many businesses cannot afford the high investment, extensive development, and ongoing maintenance costs of supporting such advanced-functionality call centers. Of course, all businesses would benefit from a reduction in the cost, time and management effort in maintaining an advanced-functionality call center.

Consequently, a clear need exists for an affordable, efficiently operable, flexible, distributed, scalable call center capable of handling not only the traditional telephone capabilities, but also supporting the new communication channels in a unified system architecture.

### SUMMARY OF THE INVENTION

Thus, a general purpose of the present invention is to provide an efficient, flexible call center architecture that enables customer support transactions to be handled by both local and remote agents in a cost and management effective manner.

This is achieved in the present invention through the implementation of a call center server architecture supporting service transactions between service customers and service agents, where the service agents can be either local to or in geographic distributed locations relative to the call center. The call center server architecture includes an inbound voice packetizer providing a PSTN line interface to the call center, a call center server system, coupled to said inbound voice packetizer, that provides for the execution of call center server control applications, and a router, coupled among said inbound voice packetizer, the call center server system, and, through a network interface to any combination of intra- and extranets, to service agent terminal equipment. The call center server control applications dynamically determine the routing and distribution of service requests received from service customers to service agents and are dynamically responsive to determinations of inadequate quality of service for individual communications channels. The call center server control applications provide for the controlled interruption of a predetermined service transaction while establishing a new communications channel having an adequate quality of service.

An advantage of the present invention is that call center agent connection configuration changes can be handled dynamically by the call center server system without terminating customer service transactions. Dynamic configuration enables the call center to flexibly handle both explicit and implicit agent location change requests. Dynamic configuration also allows easy administrative oversight and cost management of communication channel options.

Another advantage of the present invention is that the call center server system is able to utilize multiple communications channels of the same and different types. Multiple, redundant Internet connections, through independent Internet Service Providers, maximally ensure the availability of network, including VoIP, connectivity between the call center and both service customers and service agents. Selective use of separate network and PSTN communications channels further ensures connectivity at all times.

A further advantage of the present invention is that the call center server system is able to automatically perform switch-overs between different communications channels. Switch-overs can be performed transparently in certain cases with respect to the service customer. In other cases, the transaction is automatically and professionally handled to bridge the short time required to reestablish a communications connection with an agent. In all events, the present invention preserves the integrity of the service transaction.

Still another advantage of the present invention is that the call center server system is able to automatically detect the need to perform a communications channel switch-over and determine the best channel to select. The present invention continuously monitors the agent connection to detect system addressing changes and the quality of service. The availability and cost requirements of particular ISPs and routes to certain geographical locations can also be monitored and used to control the selection of communication channels.

These and other advantages of the present invention will become readily apparent upon consideration of the following detailed description of the preferred embodiments of the present invention and the accompanying drawings, wherein like parts are designated by like reference numerals.

### BRIEF DESCRIPTION OF THE DRAWINGS

FIG. 1 is a block diagram illustrating a preferred embodiment of the present invention operating in a preferred network environment.

FIG. 2 is a block diagram illustrating the preferred architecture and operative control connections of a call center as implemented by a preferred embodiment of the present invention.

FIG. 3 is a relationship flow diagram illustrating the preferred control processes implemented by a call center server system in accordance with a preferred embodiment of the present invention.

### DETAILED DESCRIPTION OF THE INVENTION

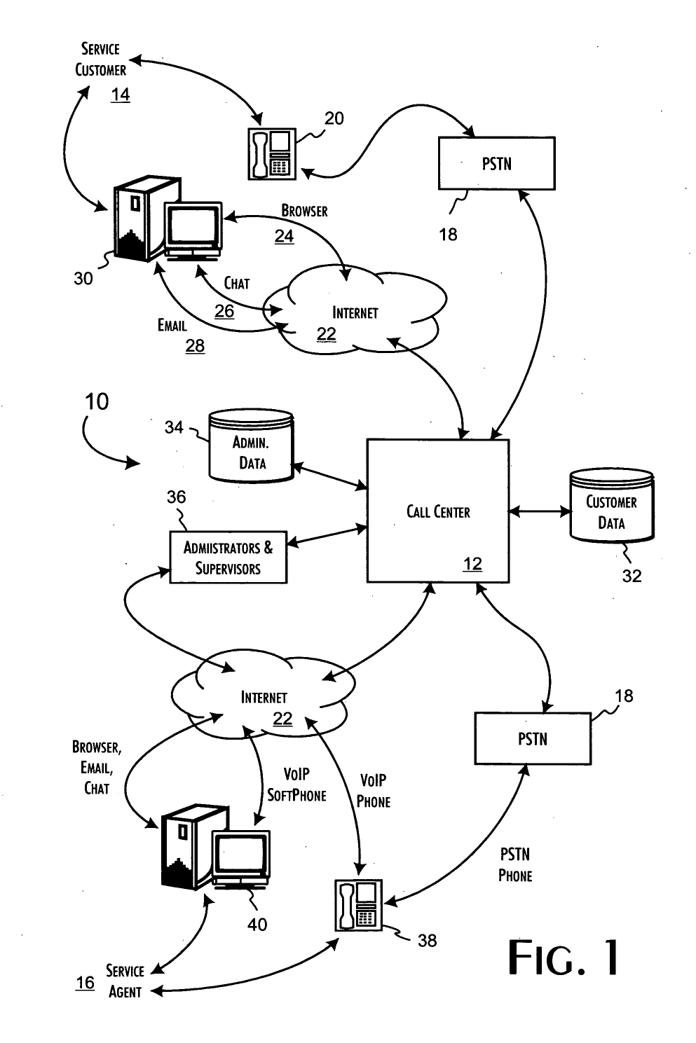

The present invention enables the efficient operation of a customer support call center in establishing and maintaining qualified and cost-effective communications connections between a service customer and service agent through the call center. As generally shown in FIG. 1, the operating architecture 10 of a call center 12, constructed in accordance with the present invention, hosts service transactions between any number of service customers 14 and any number of concurrently available service agents 16. As detailed in copending U.S. application Ser. No. 09/981,550, entitled Method of and Apparatus for Allowing Customer-Agents to Perform Every Phone, Chat, Email and Web Callback Transaction in a Single Screen, which is assigned to the Assignee of the present application, and which is hereby expressly incorporated by reference, the call center 12 implements a call center server system that executes control applications to receive service customer calls, manage individual calls using interactive voice response (IVR), perform automated call distribution (ACD) selection of service agents 16 to match agent skills and availability to customer service requests, PSTN and VoIP call routing to establish individual service transactions.

In summary, the call center 12 is connected to the PSTN 18 to receive voice calls placed using customer PSTN equipment 20 and to the Internet 22 to receive customer service requests using different protocols, typified by Web browser 24, Internet chat 26, and email 28 communications from client applications executed on a customer computer system 30. The call center 12 evaluates customer service requests against available customer data 32 to determine support qualifications and against administrative data 34 to identify available skills-appropriate customer service agents 16 suitable to receive the qualified service requests. Preferably, the skills portion of the administrative data 34 is created and maintained by call center administrators and supervisors 36, either directly or by suitably secure Internet 22 connections to the call center 12. The administrative data 34 is also relied upon to determine the most effective manner of routing the service request to the appropriate service agent 16. The routing administrative data 34 is preferably generated in part automatically by network monitoring operations of the call center 12.

In accordance with the present invention, the routing determination made by the call center 12 for voice-based customer service requests can result in the establishment of a voice connection to a service agent 16 using a PSTN connection 18 to agent PSTN-capable telephone equipment 38 or through one of several different Internet 22 connections to an agent VoIP softphone 40, or agent VoIP-capable telephone equipment 38. Relevant customer data 32 and communications data provided by the customer through any of the Web browser, email and chat protocols is also routed by the call center 12 to the agent computer system 40.

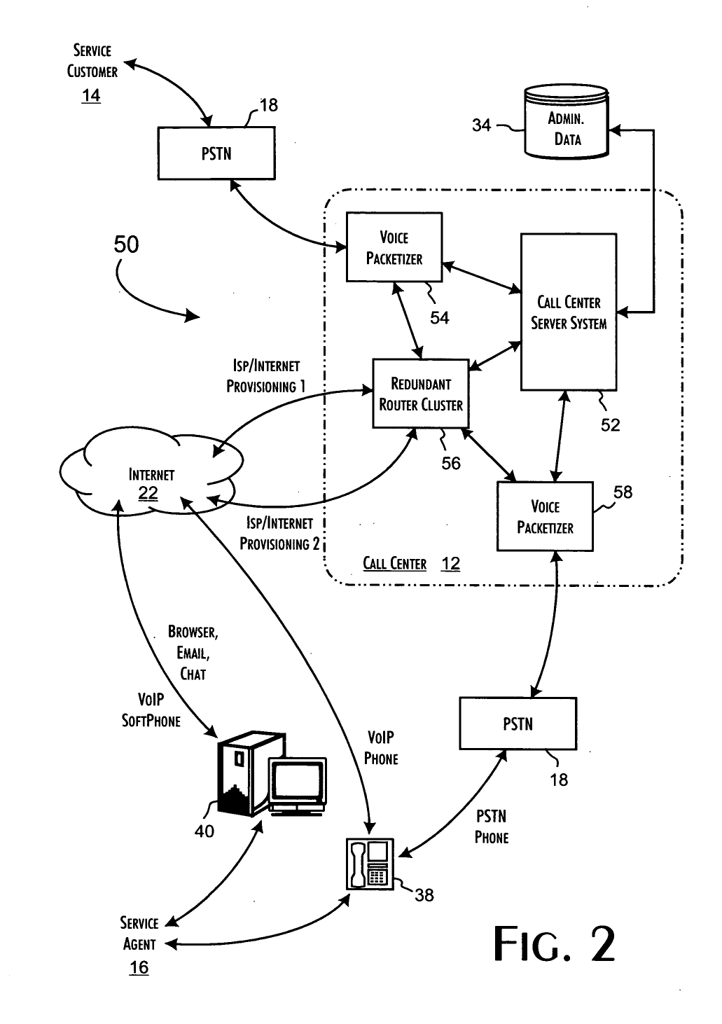

A preferred architectural implementation 50 of the call center 12, specifically in regard to the handling of voice communications, is shown in greater detail in FIG. 2. A call center server system 52, implemented using a conventional server computer platform and executing a standard distribution of the Linux Operating System, provides for the execution of the call center application programs noted above. The call center server system 52 interfaces with a voice packetizer 54 that serves to terminate PSTN central office (CO) lines and convert between conventional analog and VoIP packet voice streams. In a preferred embodiment of the present invention, the voice packetizer 54 is implemented using a Cisco 3662-AC/DC-CO Multi-service Access Platform, manufactured by Cisco Systems, Inc., San Jose, Calif. The call center server system 52 executes a computer telephony integration (CTI) application that, in combination with the voice packetizer 54, preferably implements an interactive voice response (IVR) system that allows the call center server system 52 to effectively operate as a virtual PBX system in handling incoming voice calls.

The call center server system 52 executes an automated call distribution (ACD) application that, based on the IVR selections and matching customer data 32, determines the assignment of the call to an appropriate service agent queue. In effect, the call center server system 52 holds the call transaction open pending the establishment of a communications connection when the assigned service agent 16 becomes available. In determining the call assignment, the ACD application preferably considers a number of factors including the skills of groups and individual customer agents currently logged-on, and thereby available for assignment of call queues, the available communications routes to the skill appropriate groups and individual customer agents, and the costs associated with those routes. In a preferred embodiment of the present invention, the call center 12 has available multiple Internet connections through independently provisioned connections, potentially using different ISPs, preferably chosen on the basis of path diversity over major Internet backbone segments and which may further offer different cost structures depending on the desired connection quality and eventual destination. The call center 12 preferably also has available one or more conventional connection paths through the PSTN 18 to service agents 16 with rate charges that may differ depending on the regional connection destination or other factors.

Preferably, the VoIP packetized data streams handled by the voice packetizer 54 are routed through a redundant cluster of routers 56 that permit programmable selection of communications path routing under the control of the call center server system 52. The routers 56 are preferably connected to independent ISPs, shown as ISP1 and ISP2, which provides for redundancy in the connection to the Internet 22 and, further, the potential to select different ISP communications cost structures dependent on the nature of the ultimate connection being made. The routers 56 are preferably also connected to the call center server system 52. This allows the call center server system 52 to operate at least as a VoIP voice stream source of typically prerecorded advisory messages that can be played at appropriate times to the service customer 14 and, potentially, a particular service agent 16.

Where the ACD application determines to complete a VoIP-based communications connection with an available service agent 16, the call center server system 52 controls the routers 56 to direct the VoIP voice stream to the current IP address assigned to the VoIP softphone application executed on the agent computer system 40 or the VoIP terminal equipment 38 of the service agent 16. Where instead the ACD application determines to complete a communications connection to a service agent through the PSTN 18, the VoIP voice stream is routed through a second voice packetizer 58, the PSTN 18, and to the service agent 16. In a preferred implementation of the call center server system 52, the voice packetizers 54, 58 are the same physical device. The inbound and outbound VoIP voice streams are simply routed by the router 56, as a softswitch operated under the control of the call center server system 52, through separate CO ports of the single physical voice packetizer 54, 58.

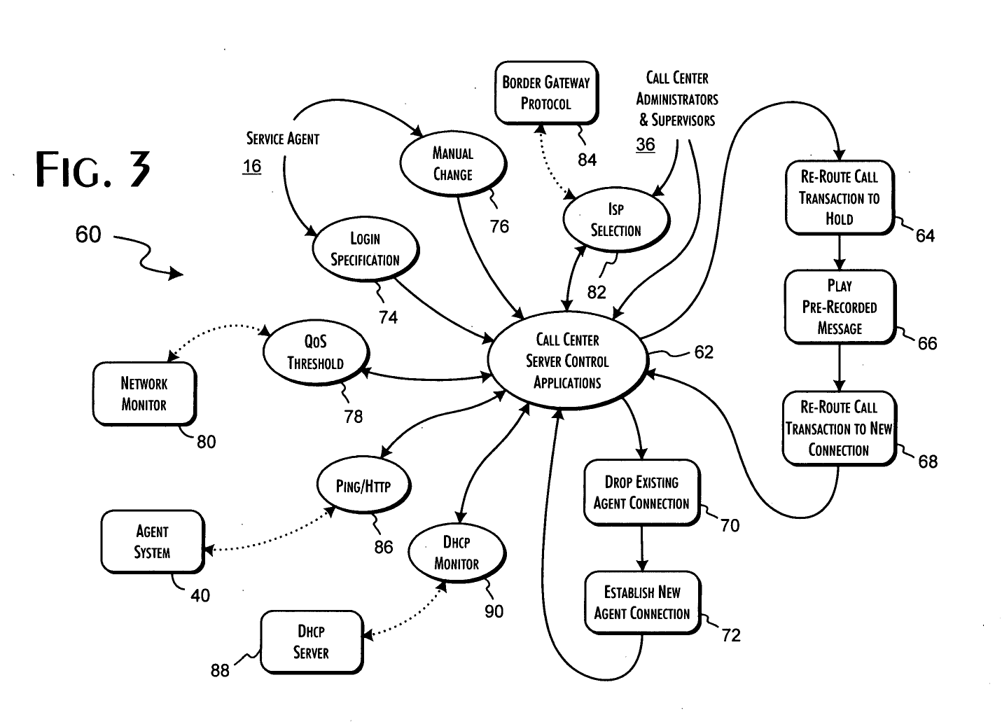

The preferred operation of the call center server system 52 is further detailed in the relationship flow diagram 60 presented in FIG. 3. The cooperative operation of the call center server control applications 62 executed on the call center server system 52 control the functional behavior of the call center 52. Aspects of this behavior depend on identifying an individual service agent 16, determining when the agent is available to respond to customer service requests, establishing the preferred primary and alternate voice-based communications channels and channel addresses for contacting the agent, and ensuring the integrity of the agent communications channel in terms of both active accessibility and effective quality of service (QoS).

Central to the operation of the coil center server control applications 62 is the ability to suspend or hold a customer service transaction while reestablishing a dropped or inadequate quality of service communications channel with a service agent 16. A dropped communications channel with a service agent 16 typically occurs as a result of some transient interruption in the Internet 22 or PSTN 18 networks. A loss of adequate quality typically occurs due to excessive packet loss or latency in an Internet connection or crosstalk in a PSTN 18 connection. In some cases, the call center server control applications 62 can coordinate the establishment and substitution of an alternate communications connection with the service agent 16 without an interruption in the service transaction noticeable to the service customer 14. In many cases, however, the call center server control applications 62 are required to temporarily hold the transaction while reestablishing the communications channel with the service agent 16.

To temporarily hold a customer service transaction, the call center server control applications 62 can operatively direct a rerouting 64, by the routers 56, of the transaction voice stream to the call center server system 52. A digitized message, either prerecorded or synthesized by the call center server system 52 based on selected administrative data 34, is played 66 to the service customer to explain the service interruption. Once the communications channel with the service agent 16 is reestablished, the customer service call transaction is rerouted 68 through the routers 56 to use the new communications channel.

Once the call transaction has been rerouted to the call center server system 52, the dropped or existing agent communications channel is cleared 70. The call center server control applications 62 then choose and establish 72 an alternative communications channel with the service agent 16. As soon as the service agent is available using the new communications channel, the call center server control applications 62 can reestablish the transaction 68 between the service customer 14 and service agent 16.

The initial availability of a service agent 16 to participate in customer service transactions is preferably established by the agent logging into the call center 12. As part of the login procedure, the service agent 16 provides a call-back specification 74 that identifies the type and address of the communications channel preferred by the individual service agent 16. The call-back specification 74 can be re-supplied by the service agent 16 between service request transactions to allow for changing circumstances. Thus, for example where a service agent 16 is working from a home location, the agent can provide an Internet call-back specification 74 and then, later in the day, when family use of the local Internet connection compromises throughput, stop using the VoIP channel and re-supply the call-back specification 74 to provide a PSTN number. So, for certain hours of the day, the system can be directed to route calls through the PSTN, but during other hours use the Internet.

The call-back specification 74 preferably provides the call-back address in the form of a string containing a full target IP address, a soft target IP identifier, a full telephone number, an extension number, or in an alternate embodiment of the present invention, an agent contact profile number. Since the minimum agent equipment supported is a conventional PSTN handset, the call-back specification 74 is preferably represented as a numeric string producible using a conventional PSTN touch-tone keypad.

Where a full target IP address is being provided, a VoIP prefix code is pretended to the IP address to specify that a VoIP call-back is desired. The VoIP prefix code is preferably a numeric string chosen to ensure that the call center server system 52 recognizes the call-back specification 74 as representing a VoIP request and containing a VoIP server address. In a preferred embodiment of the present invention, the fixed VoIP prefix code is 012. This choice of VoIP prefix code is made to ensure that the VoIP call-back specification 74 can be automatically differentiated from a standard telephone number. A 011 prefix is identified as a PSTN country code for the Phillippines, whereas 012 does not match any current PSTN-standard country code. Thus, given an agent target IP address of 03.15.15.256, for example, the agent entered call-back specification 74 for a VoIP call-back request is 012 003 015 025 015 256. In response, the call center server system 52 can then, further based on the recognized IP address, select an optimal ISP connection and dynamically configure the routers 56 to establish the VoIP connection on demand.

Alternately, the service agent 16 need only provide the VoIP prefix code when using the agent computer system 40 to execute a softphone VoIP application. The Web server application executed by the call center server system 52 that supports Web-based agent login services can directly determine the IP address of the agent computer system 40. Thus, providing only the VoIP prefix code as the call-back specification 74 instructs the call center server system 52 to direct VoIP connections to the agent computer system 40 without requiring the service agent 16 know or enter an IP address.

Where a telephone number or internal extension number is provided as the call-back specification, the call center server control applications 62 directs the operation of the routers 56 and, as needed, voice packetizer 58 to route local VoIP and PSTN communications channels. The extension number, in an alternate embodiment of the present invention, can be used to represent a virtual profile for either a location or individual service agent. Where the extension number is, by convention implemented by the call center server control applications 62, associated with a physical location, or more specifically with a fixed set of communications equipment, the extension number can be used to reference administrative data 34 to determine a corresponding set of administratively set IP addresses and PBX extension numbers. If the extension number is, by convention, treated as an agent identifier, the retrieved administrative data 34 preferably represents a corresponding set of agent established and prioritized IP addresses and telephone numbers to be used in contacting the service agent. Preferably, this agent profile data can be changed at-will by the service agent 16 through own-account administration Web pages supported by the call center server system 52.

In accordance with the present invention, manual reconfigurations of the routing tables used to control the routers 56 are not required. Rather, the routing configuration can be automatically determined and flexibly changed based on information provided by the service agent 16 when logging into the call center server system 52. No limitation is imposed on the location of the service agent 16 when providing a call-back specification 74. Further, no administrative overhead is necessarily incurred in managing agent location and equipment changes. Additionally, the known availability of a service agent 16 via a VoIP communications channel may be used by the ACD element of the call center server control applications 62 to affect the call center priority and preferences used in selecting the service agent 16 to handle call request transactions.

Preferably, a service agent 16 can also direct a change in the current communications channel being used during a customer service transaction. The service agent 16 is preferably provided with a Web page presenting transaction related customer data 32. This Web page preferably presents a user interface control 76 that allows the service agent 16 to request a communications channel change, typically used in the case where the agent determines that the quality of service of the existing communications channel is inadequate. In a preferred embodiment of the present invention, the user interface control is a Web page button that signals the call center server control applications 62 to select and establish the best alternative communications channel. In an alternate embodiment of the present invention, the user interface control 76 allows the service agent 16 to explicitly provide or at least request use of a different call-back specification. Where the change in communications channel only requires a change in the Internet provisioning or ISP used to establish the channel, the change in communications channel may be made without noticeably interrupting the customer service transaction. Where the communications channel change does necessitate a transaction interruption, the call center server control applications 62 hold the transaction 64, 66, 68 while reestablishing the chosen communications channel 70, 72.

In accordance with a preferred embodiment of the present invention, the call center server control applications 62 can automatically detect quality of service failure in a VoIP communications channel 78, here defined by thresholds representing a predefined packet latency, a predefined level of packet loss, and optionally a predefined combination of packet latency and packet loss. For example, the threshold packet latency can be set at 200 milliseconds and the dropped packet level at 10 percent as a running average over a defined time interval. The routers 56 preferably include a network monitor 80 that can be periodically polled by the call center server control applications 62 to determine the quality of service thresholds 78 for each routed VoIP path. Whether on initiating a communications channel for a new service transaction or in the midst of an ongoing service transaction, when a routed VoIP path determined as qualifying as a quality of service failure, the transaction is held 64, 66, 68 while a different communications channel is selected and established 70, 72.

The call center server control applications 62, in accordance with a preferred embodiment of the present invention, also monitor the status of communications channels based on the Internet provisioning and ISPs being used for particular transactions. The call center server control applications 62 can interoperate 82 with an implementation of the border gateway protocol (BGP) or similar router control protocol 84 to explicitly monitor and manage the routing of particular VoIP communications channels. A dropped communications channel will be quickly identified as a sudden quality of service failure. By supporting, in the interface between the routers 56 and Internet 22, redundantly provisioned Internet connections potentially supported by different ISPs, the call center server control applications 62 have the flexibility to choose between potentially different cost structures offered by ISPs. For example, one ISP may offer a better cost structure for connections between the United States and Europe while a different ISP may offer cost savings for United States connections to the Far East. This flexibility also allows the call center server control applications 62 to effectively route around failures that may affect one ISP but not another. Thus, while an initially VoIP-based transaction is held, the call center server control applications 62 can attempt to establish a new VoIP communications channel using different Internet provisioning connections and ISPs before resorting to the establishment of a significantly more costly PSTN-based communications channel. This procedure of preferentially hunting for alternate VoIP-based communications channels is also preferably employed in cases where there is an intermittent or progressive quality of service failures.

The call center server control applications 62 depend on having the current IP address for the VoIP equipment used by a service agent 16. Due to the nature of the VoIP protocol, the service agent terminal equipment is configured as the IP connection server and the call center 12 operates as the VoIP client. Conventionally, the service agent VoIP terminal equipment must therefore have a statically assigned IP address known to the call center 12. Typical service agent terminal equipment, specifically a VoIP softphone application, depends on and uses an Internet connection maintained by the underlying personal computer. Also typically, such personal computers are dynamically allocated IP addresses, using the Dynamic Host Configuration Protocol (“DHCP”), and are subject to changes in the assigned IP address as IP leases are expired or released.

In accordance with the present invention, to maintain a VoIP communications channel, the call center server control applications 62 preferably implements a dynamic monitor of the service agent terminal equipment for changes in the assigned IP address. In a preferred embodiment of the present invention, an applet or similar program is executed on the service agent terminal equipment to periodically provide a data packet to the call center server control applications 62. Each provided packet embeds a source IP address and thereby enables the call center server control applications 62 to track any IP address change. Thus, a statically assigned IP address for every VoIP telephone is not required.

As implemented in a preferred embodiment, the IP address detection applet is embedded in the Web page served by the call center server control applications 62 to present customer data to the service agent. The applet executes on the computer system 40 used by the service agent 16 as a VoIP softphone and periodically issues 86 a conventional ping data packet to the local network interface. The ping response data packet returns the current IP address of the computer system 40. Any change in the reported IP address is noted and then sent by the applet in a network message to the call center server control applications 62. The following client/call center 12 IP packets continuing the VoIP communications channel are automatically updated with the new IP address of the service agent terminal equipment.

Alternately, where access to the supporting DHCP server 88 is available, the call center server control applications 62 can directly monitor 90 changes in the agent assigned IP addresses. Optionally, the call center server control applications 62 can influence or control the expiration timing of DHCP IP address leases to minimize impact on active customer service transactions.

Thus, a system and methods for providing for the efficient operation of a customer support call center in establishing and maintaining qualified and cost-effective communications connections between service customers and service agents through the call center has been described.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A call center server architecture enabling the establishment and maintenance of a service transaction between a service customer and a service agent, wherein said service agent can be either local to or in a remote geographic location relative to the physical installation of a call center server, said call center server architecture comprising:
a) an inbound voice packetizer providing a PSTN interface between a service customer and said call center server architecture, said inbound voice packetizer providing for the bidirectional conversion between PSTN and VoIP voice data streams;
b) a call center server system coupled to said inbound voice packetizer and providing for the execution of call center server control applications; and
c) a router coupled to said inbound voice packetizer and to said call center server system and having a network interface through which to route communications connections to service agent terminal equipment, wherein said call center server control applications are operative to dynamically determine the routing and distribution of service requests received from service customers to service agents via associated service agent terminal equipment, wherein said call center server control applications are dynamically responsive to determinations of inadequate quality of service for individual communications channels established between said call center server system and predetermined service agent terminal equipment, said call center server control applications providing for the controlled interruption of a predetermined service transaction while establishing a new communications channel having an adequate quality of service.

2. The call center server architecture of claim 1 wherein said network interface provides for multiple provisioning connections to the Internet and wherein said call center server control applications alternately attempt to establish said new communications channel through said multiple provisioning connections.

3. The call center server architecture of claim 2 further comprising an outbound voice packetizer providing a PSTN interface between said call center server architecture and service agent terminal equipment, said outbound voice packetizer providing for the bidirectional conversion between PSTN and VoIP voice data streams, wherein said call center server control applications alternately attempt to establish said new communications channel through said outbound voice packetizer.

4. The call center server architecture of claim 3 wherein said call center server control applications operate to attempt to establish said new communications channel via said multiple provisioning connections and said outbound voice packetizer based on predetermined priorities.

5. The call center server architecture of claim 4 wherein said call center server control applications monitor for said determinations of inadequate quality of service provided by a service agent signal and by analysis of VoIP voice stream data.

6. The call center server architecture of claim 5 wherein said call center server control applications determine a quality of service failure based on predetermined factors including where the VoIP voice stream packet latency exceeds a predetermined latency threshold and where the VoIP voice stream packet drop rate exceeds a predetermined dropped packet threshold.

7. The call center server architecture of claim 6 wherein said predetermined priorities include agent specified terminal equipment selections and preestablished communications channel rate schedules.

8. The call center server architecture of claim 7 wherein said call center server control applications further monitor for dynamic changes in the IP address assigned to agent terminal equipment, said call center server control applications supporting establishment of said new communications channel using a newly identified IP address corresponding to established agent terminal equipment.

9. The call center server architecture of claim 8 wherein said call center server control applications monitor for dynamic changes in the IP address assigned to agent terminal equipment by providing for the remote execution of agent terminal equipment specific programs.

10. The call center server architecture of claim 9 wherein a predetermined agent terminal equipment specific program polls the local agent terminal equipment executing said predetermined agent terminal equipment specific program to determine the IP address of said local agent terminal equipment, and wherein said predetermined agent terminal equipment specific program provides a network message, relative to said local agent terminal equipment, specifying a changed IP address to said call center server control applications.

11. A method of operating a call center server system to establish and maintain service request transactions between service customers and service agents wherein the service agents may be, in any combination, local to a call center and geographically distributed, said method comprising the steps of:
a) first monitoring, by call center server control applications executed by a call center server system, the quality of service of VoIP communications channels connecting a call distribution facility to each of a plurality of service agents;
b) second monitoring, by said call center server control applications, the assigned IP address of VoIP communications equipment utilized by each of said plurality of service agents; and
c) dropping and establishing a new communications channel automatically by said call center server control applications in response to predetermined circumstances including where a predetermined communications channel is determined a quality of service failure or where the assigned IP address of the VoIP communications equipment utilized by a predetermined service agent has changed.

12. The method of claim 11 wherein said step of dropping and establishing, dependent on the existence of an established service transaction on said predetermined communications channel, includes the steps of:
a) routing, under the control of said call center server control applications, a customer service transaction to said call center server system;
b) injecting, by said call center server control applications, a predetermined message to said customer service transaction; and
c) rerouting, by said call center server control applications, said customer service transaction to said new communications channel.

13. The method of claim 12 wherein said predetermined circumstances further includes a request by said predetermined service agent to switch to said new communications channel, said call center server control applications being responsive to a network message provided from the terminal equipment utilized by said predetermined service agent.

14. A method of operating a call center server system to establish and maintain service request transactions between service customers and service agents, wherein service request transactions are conducted over a VoIP communications channel segment with service agents that are geographically distributed relative to a call center, said method comprising the steps of:
a) providing multiple provisioning of Internet connections to a call distribution facility to support a selectable diversity of VoIP communications paths between said call distribution facility and each of a plurality of remotely located service agents;
b) identifying, based on respective preferences specified by said plurality of remotely located service agents, preferred remotely located VoIP terminal devices for use in conducting service request transactions respectively with said plurality of remotely located service agents;
c) monitoring of conditions, by control applications executed by said call center server system, including the quality of service on VoIP communications channels connecting said call distribution facility respectively to said plurality of remotely located service agents; and
d) maintaining, by said call center server system, a predetermined service request transaction between a respective service customer and corresponding one of said plurality of remotely located service agents while dropping, by said control applications, an existing VoIP communications channel, corresponding to said predetermined service request transaction, where the quality of service of said existing VoIP communications channel falls below a predetermined threshold and establishing a new VoIP communications channel, corresponding to said predetermined service request transaction through which to continue said predetermined service request transaction.

15. The method of claim 14 wherein said step of identifying includes the steps of:
a) receiving a call-back specification from a predetermined service agent; and
b) determining based on said call-back specification the type and preferred routing for establishing service request transactions through said call center with said predetermined service agent.

16. The method of claim 15 wherein said control programs operate to decode from said call-back specification information sufficient to for said control programs to determine a VoIP Internet address corresponding to a remotely located VoIP terminal device designated as preferred by said predetermined service agent.

17. The method of claim 16 wherein said call-back specification information can include an explicit Internet address, an implicit reference to an Internet address, and an indication for said control programs to determine an Internet address based on a packet source Internet address.

18. The method of claim 17 wherein said step of monitoring further monitors for VoIP communications channel change requests, provided by said plurality of remotely located service agents, to perform said step of maintaining for respective VoIP communications channels.

19. The method of claim 18 wherein said predetermined service agent can initiate a VoIP communications channel change request during said predetermined service request transaction.

20. The method of claim 19 wherein said step of monitoring further monitors for dynamic changes in the IP address previously identified for the preferred remotely located VoIP terminal devices of said plurality of remotely located service agents, and wherein said control applications responsively initiate said maintaining step for corresponding service request transactions.
